(19) United States
(12) Patent Application Publication
(10) Pub. No.: US 2023/0158514 A1
(43) Pub. Date: May 25, 2023

(54) CENTRIFUGE AND METHOD FOR OPERATING A CENTRIFUGE

(71) Applicant: GEA MECHANICAL EQUIPMENT GMBH, Oelde (DE)

(72) Inventors: Axel BARTSCHER, Oelde (DE); Heinz HINZE, Beckum (DE); Jürgen MACKEL, Oelde (DE); Kathrin QUITER, Drensteinfurt (DE); Nico WENNEMER, Lippetal (DE); Stefan PECORONI, Oelde (DE); Tim HUNDERTMARK, Gütersloh (DE)

(73) Assignees: GEA MECHANICAL EQUIPMENT GMBH, Oelde (DE); GEA MECHANICAL EQUIPMENT GMBH, Oelde (DE)

(21) Appl. No.: 17/916,226

(22) PCT Filed: Mar. 24, 2021
(86) PCT No.: PCT/EP2021/057604

§ 371 Date: Sep. 30, 2022

(30) Foreign Application Priority Data
Apr. 3, 2020 (DE) 10 2020 109 382.9

(51) Int. Cl. B04B 9/02; B04B 1/20; B04B 13/00

(52) U.S. Cl. CPC B04B 9/02; B04B 1/2016; B04B 13/00

(57) ABSTRACT

A centrifuge includes a rotatable rotor and an assembly that is stationary during operation. The rotatable rotor is rotatably mounted in or on the stationary assembly by one or more mounting devices. The rotatable rotor has a rotatable drum and a drive element for rotating the drum as well as one or more electrical loads located on or in the rotor. The centrifuge includes at least one battery is also located on or in the rotor in order to supply the at least one load or the plurality of loads with electrical power. The load can include a data memory in the rotor or on the rotor. At least one actuator is provided as the at least one load.

### BACKGROUND AND SUMMARY OF THE INVENTION

Exemplary embodiments of the invention relate to a centrifuge and a method for operating a centrifuge. Generic centrifuges—but also centrifuges according to the invention—have a rotor that rotates during operation or which is rotatable during operation. This rotor comprises at least one rotatable drum, in which a suspension to be processed is separated into different phases. However, the rotor may also comprise other elements such as a drive spindle. The rotor may also have at least one or more electrical consumers—in the electrical sense a load—such as an actuator or an energy-requiring sensor or an initiator, which thus co-rotates with the other element or elements of the rotor rotating in operation.

EP 3 415 239 A1 proposes that the rotatable rotor of a generator assembly is entirely in a magnetic field and continuously generates current that is rectified and smoothed by a capacitor for use by actuators and sensors.

The same applies to EP 3 533 522 A1, in which it is proposed to construct a transformer in such a way that the primary coil is mounted on the stationary side and the secondary coil on the rotating side of the transformer core.

U.S. Pat. No. 6,011,490 discloses generating a local magnetic field with a stator magnet on the frame of the separator, which repeatedly passes through a coil on the drum of the separator. The induced current is rectified, smoothed and limited by a voltage regulator. In this way, it can be used by loads such as sensors in the drum.

U.S. Pat. No. 5,529,566 proposes arranging the rotor of a generator arrangement on a decanter shaft and rotating it in a magnetic field of a permanent magnet. The continuous current generated is conditioned so that it can be used by loads such as sensors and signal transmitters.

Exemplary embodiments of the invention are directed to ensuring, in a simple way, a sufficient supply of electrical power to a load in or on the rotor.

In addition, according to a solution that can be considered both as a further development but also as an independent invention, it should be possible to exchange information in a simple manner with the electrical load from outside the rotating system.

In addition, according to a further development, but also as an independent invention, it should be possible to exchange information with the load in a simple manner at a location outside the rotor.

According to embodiments, a centrifuge is provided comprising a rotatable rotor and an assembly which is stationary in operation, wherein the rotatable rotor is rotatably mounted in or on the stationary assembly by means of one or more bearing devices, wherein the rotatable rotor has a rotatable drum and an element for rotating the drum, and one or more electrical loads arranged on or in the rotor, wherein at least one battery for supplying electrical power to the at least one load or the plurality of loads is further arranged on or in the rotor. Connections of the battery may be connected directly or via intermediate components to the respective load. The drive element may be a drive spindle or another element suitable for this purpose. The at least one load is an actuator. Further loads may be provided, in particular further actuators or other loads.

The battery, which can be rotated together with the rotor, can be used to easily provide electrical power on or in the rotor in order to supply the load(s) on or in the rotor with electrical power. In this context, the battery can also be used in the idle state—i.e., when the rotor is at a standstill—to continue supplying the load with energy.

Thus, buffered energy is also available when the drum is stationary due to the battery rotating with the rotor as it turns. This offers some advantages that have been surprisingly overlooked in previous developments for supplying loads in rotatable rotors of centrifuges. This is because one overlooked disadvantage of the known centrifuges mentioned at the outset is that only when the rotor is turning or rotating electrical power is available for the actuators or optionally other loads such as one or more sensors and/or data communication and/or data processing. When the drum is at rest, on the other hand, no electrical power is available to supply the actuators, sensors and data communication and data processing. This problem is solved in a simple way by the invention.

According to the invention, the loads can thus be supplied, for example, with a corresponding design of the rotors. Thus, the actuator or actuators can be operated or moved as loads even when the drum is stationary and/or data and/or signals from sensors and feedback signals from actuators can be transmitted when a corresponding transmitting and/or receiving unit is provided on the rotor. This can be advantageous for a variety of reasons, for example according to a variant to perform a temperature measurement in a cooled (chamber) drum for sensitive products, when a maximum temperature of the drum must not be exceeded before it is loaded with product to be processed. Another example is a filling level measurement, which can also be useful for a stationary drum.

Another advantage offered by a battery associated with the rotor and rotating with it is that it can be used directly or, optionally, in conjunction with other electrical components to provide relatively high electrical power, for example to actuate one or more actuators such as one or more closing valve(s), in particular designed as solenoid valve(s), or control valves of the drum.

According to a further development, which can also be regarded as an independent invention, it is provided that the load or loads of the rotating system comprise one or more actuators designed to change the cross-section of and/or open and close devices such as openings or lines, in particular solids discharge openings or discharge lines on the drum, with the aid of electrical power.

According to an advantageous variant of the invention(s) explained above, a disc pack is arranged in the drum, which has a stack of separating discs. The drum can then preferably also be of single or double conical design on the outside and/or inside. Especially on centrifuges, in particular separators, with such drums, it is particularly advantageous to be able to electrically operate one or more actuators, in particular one or more valves, with which solids discharge openings can be opened and closed, in particular in the area of the largest radius of the drum, namely during operation of the drum when the drum is rotating but also when the drum is stationary and not rotating.

The actuator(s) can be designed in particular as one or more electrically controllable valves.

In this way, it is easy to open and close openings or lines, in particular solids discharge openings or drain lines on the drum with the aid of electrical power.

According to a preferred design, the battery or one of the batteries is designed as a rechargeable battery. However, it is also conceivable that the battery or one of the batteries is designed as a non-rechargeable battery, which then has to be changed occasionally when the rotor is at a standstill. It can be advantageously provided—according to a further development, but which can also be regarded as an independent invention—that the load comprises a data memory in the rotor or on the rotor. This is because, according to this particularly advantageous variant of the invention, it becomes possible to store data directly on or in the rotor concerning the operation of the centrifuge and, in particular, the operating behavior of the centrifuge, and then to read them out as required and to transmit them, for example by radio, to an area outside the rotor, for example to a stationary control device. Alternatively, it is possible to store and/or evaluate these data directly in the rotor, if or for which purpose a suitable computer facility is then available there.

According to a further advantageous variant of the invention, it may further be provided that the load comprises one or more of the following devices: a sensor, an actuator and/or an initiator and/or a transmitting and/or receiving unit and/or a control unit in or on the rotor.

The bearings of the rotor can be designed as mechanically operating bearings, for example as rolling bearings, or also as magnetically operating bearings. If energy is required for their operation, they can—as one of the loads—be supplied with energy from the battery, but optionally also by other means.

The rotor may include the drum, and may further include a rotatable drive spindle that is non-rotatably coupled to the drum and that is rotated by a drive motor. However, the drum may also be driven or rotated without contact (e.g., with a magnetic coupling or with a levitronically acting drive system).

It may further be provided that the centrifuge has an arrangement for generating electrical power, which is designed in such a way that the electrical power is provided on or in the rotor, and that a charging circuit for charging the rechargeable battery is provided on or in the rotor. For in this way the battery can be directly charged or recharged during operation of the centrifuge. Such arrangements are known in a wide variety of designs, for example from the prior art mentioned at the beginning, to which reference can be made in this respect. Such an arrangement can be used via the charging circuit to charge the battery as long as the rotor is rotating.

In this context, it is conceivable that the arrangement is designed to generate electrical power only during part of the rotations of the rotor or that the arrangement is designed to generate electrical power during the complete rotations of the rotor. By using the battery as an energy storage device, sufficient energy can be provided at a time independent of the energy generation.

This is because the invention uses the electrochemically operating battery to charge an energy store in which energy is stored that can also be released again at very short notice.

Thus, according to one variant of the invention, energy can be generated or transmitted only in a locally limited magnetic field (one or more segments). The generated current is transformed in such a way that it is used to charge the battery located in or on the rotor, the energy of which is available both when the drum is rotating and when it is stationary.

Alternatively, in the context of another invention, it is conceivable to generate electrical power outside the rotating system and then transfer it into the rotating system via a conductive connection to the battery. Thus, power transfer from a location outside the rotating system into the rotating system is possible by means of a slip ring transformer. Power transmission using the ball bearings as a transformer for the electric current is also practical and readily achievable.

The invention makes it possible in a simple manner to also supply electrical power to loads in a drum whose power requirements are temporarily or momentarily higher than the momentary power that can be generated during operation of the drum with the arrangement.

The use of the battery as an energy supply in the rotor can thus result in a wide range of advantages.

Much more energy can be drawn from the battery for short periods than with the prior art, where only the energy currently generated is available. This is very advantageous, e.g., for the short-term actuation of valves, since here there is a high but pulse-shaped energy requirement (e.g., open-close valves for solids discharge). This pulse-shaped available energy is mainly determined by the dimensioning of the battery, less by a charging current.

According to an option, data permanently belonging to the drum and documenting, for example, the history of a drum can be stored on this data memory with the aid of a memory housed in the drum. This can be, for example, data from strain gauges that register a possible exceeding of the load limit of the drum material, or operating hours of the drum that can be used to determine the maintenance intervals, or data from impermissibly high acceleration, e.g., by exceeding the permissible speed or exceeding the maximum permissible density of the product to be processed. In this way, similar to a data logger or a black box, important data can be collected and recorded directly in the drum during its lifetime.

The sensors described for the data logger, such as temperature sensors, acceleration sensors, strain gauges, limit switches, vibration sensors, etc., are installed directly in the drum and exchange the recorded measured values with evaluation electronics via cable or radio. The measured values processed by the evaluation electronics are then stored as data in a memory unit in the drum. All electrical loads can be supplied with power from the battery described above either by wire or without a wire, e.g., inductively.

In this way, the operating data of the mechanically highly loaded drum are available at any time throughout the entire life cycle of the drum and can provide information on any impermissible loads.

A particularly advantageous application of the invention is to provide one or more sensors for pressure, level, temperature, turbidity, conductivity in the rotor. These can supply data to the internal or also external data memory, wherein these data can be used to significantly improve the process engineering properties of the machine by means of evaluation by an expert system and corresponding optimization software. These data can also be sent to the control unit outside the rotor in order to directly influence process parameters such as the flow rate of the centrifuge feed, the drum speed, or the discharge frequency.

Furthermore, according to one design of the invention, it is also conceivable that sensors are provided for mechanical states (e.g., limit switches for piston slide valves) that can be interrogated to obtain conclusions about the proper functioning of the mechanical system.

In addition, a sensor system for measuring structure-borne sound, vibration or cavitation can be operated in or on the rotor.

It is also conceivable to provide ultrasonic actuators, for example to mechanically excite a separating disc or the entire disc pack in such a way that deposits are detached from the disc surface or do not adhere there in the first place.

According to an advantageous further development of one or more of the invention, as well as a design to be considered as an independent invention, it can be provided that at least one transmitting and/or receiving unit for wireless transmission and/or reception of data is further formed on the rotor. This enables communication with the one or more electrical loads of the rotor in a simple manner. According to an embodiment, data and signals are or can be exchanged in a contactless manner between the rotor and the environment—in particular with a control system of the centrifuge—for example by radio or by means of light (e.g., optical rotary transducers).

It may be provided that a corresponding transmitting and/or receiving unit for wireless transmission and/or reception of data is formed on the stationary assembly. In addition, it can be provided that the corresponding transmitting and/or receiving unit is connected to a control device for controlling the centrifuge.

Control signals for the actuators or data or signals from the sensors are then preferably communicated in a contactless or wireless manner, e.g., by radio or optically, between the drum and a receiver in the frame of the centrifuge.

From there, a data and signal communication to the control device of the centrifuge can be provided, in which the data and signals are generated or evaluated. Direct transmission of the data and signals to a data cloud is also conceivable, so that the data/signals can be processed independently of location.

According to a further advantageous embodiment, which may also be regarded as a further independent invention, a centrifuge is provided that comprises a rotatable rotor and an assembly that is stationary in operation, wherein the rotatable rotor is rotatably mounted in or on the stationary assembly by means of one or more bearing means, wherein the rotatable rotor comprises a rotatable drum and a drive element for rotating the drum, and one or more electrical loads arranged on or in the rotor, wherein the load(s) comprise(s) one or more actuator(s) adapted to act by means of electrical power on one or more openings and/or lines, in particular solids discharge openings and/or inlet or outlet lines on the drum, in particular to change the cross-section thereof, and/or to open or close the flow. In this way, changes of state can be brought about at one or more lines or openings in a simple manner by means of one or more electrically controllable actuators in order to influence the state of the centrifugal separation.

According to another variation, which in turn may also be considered as a separate invention, the invention provides a centrifuge comprising a rotatable rotor and an assembly that is stationary in operation, wherein the rotatable rotor is rotatably mounted in or on the stationary assembly by means of one or more bearing means, wherein the rotatable rotor comprises a rotatable drum and a drive element for rotating the drum. The drum further comprises a hydraulically actuated piston slide valve for opening or closing one or more solids discharge openings. In this case, hydraulic fluid, in particular control water, is discharged from a control chamber at, in particular below, the piston slide valve by means of one or more electromechanical valves, which are arranged on or in the rotating drum, for actuating, in particular opening, the piston slide valve, or it can be discharged in this way. The valve or valves form one or more of the loads. Such valves can be controlled very well and precisely. It or they are supplied with electrical power in the drum.

According to a further variant, which in turn may also be regarded as an independent invention, the invention provides a centrifuge comprising a rotatable rotor and an assembly that is stationary in operation, wherein the rotatable rotor is rotatably mounted in or on the stationary assembly by means of one or more bearing devices, wherein the rotatable rotor comprises a rotatable drum and a drive element for rotating the drum as well as one or more electrical loads arranged on or in the rotor, wherein the drum comprises solids discharge nozzles and wherein an electrically controllable device for changing the nozzle cross-section of the solids discharge nozzles is provided as a load. This device for changing the nozzle cross-section of the solids discharge nozzles is preferably designed as an electrically adjustable nozzle needle which is moved into the passage cross-section, whereby a remaining passage cross-section can be changed. However, this device can also be designed as an impact body which is electrically adjustably pushed in front of the nozzle opening so that a gap with variable gap width is formed. In this way, it is easily possible to change the cross-section of the solids discharge nozzles even during operation, which would otherwise not be possible.

Finally, the invention also provides a method for operating a centrifuge according to the description above, in which the rotor is moved from a first non-rotating state to a rotating state to separate, in a centrifugal field in the drum of the rotor, a product fed into the drum into different phases, wherein one or more loads arranged in or on the rotor are supplied with electrical power from a battery arranged in the rotor both during an operating state in which the rotor is rotated and in a state in which the rotor is stationary. This method offers, inter alia, the advantages also described with respect to the device.

It should be noted that the independent claims indicate combinations of features that can be advantageously combined individually, but also in combination with the features of one or more other alternative independent claims. In addition, the respective independent claims can also be advantageously combined with the features of all subclaims.

### BRIEF DESCRIPTION OF THE DRAWING FIGURES

Advantageous variants are explained in more detail below with reference to a preferred exemplary embodiment with reference to the attached drawings, which is not to be understood as limiting or as the only conceivable exemplary design. In particular, it is not necessary to combine all the features of the following description in all the exemplary embodiments, wherein:

FIG. 1: shows a schematic sectional view of a centrifuge which can be operated according to a method according to the invention; and

FIG. 2: shows a charging circuit for a rotor of a centrifuge according to the invention.

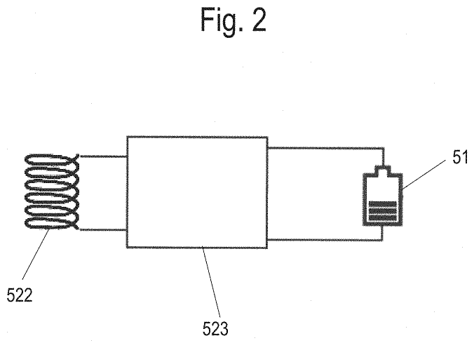

### DETAILED DESCRIPTION

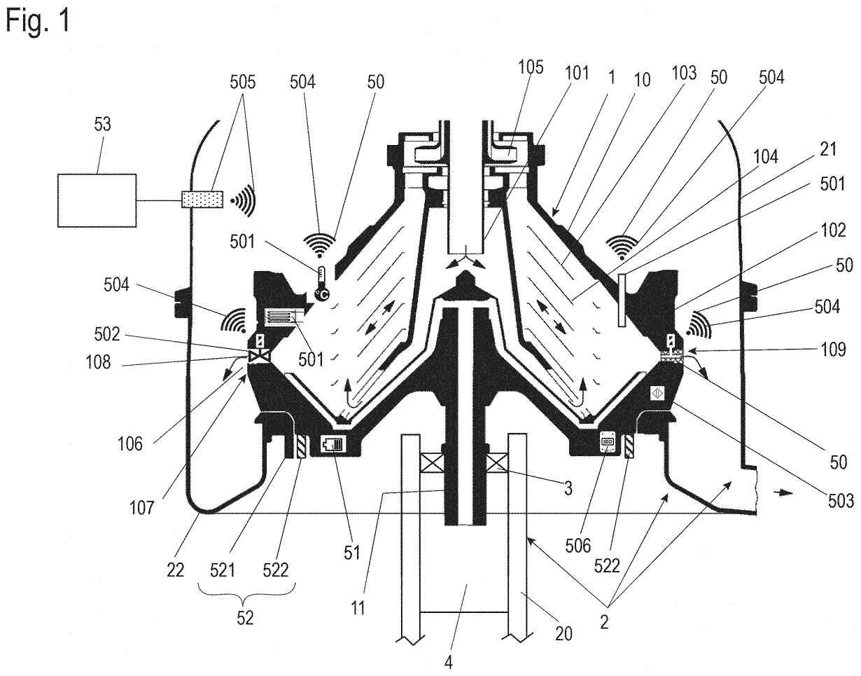

FIG. 1 shows a centrifuge with a rotatable rotor 1 and an assembly 2 that is stationary during operation. The rotatable rotor 1 and the non-rotatable assembly 2 are shown only schematically. The rotatable rotor 1 is rotatably mounted in or on the stationary assembly 2 by means of one or more bearing devices 3, wherein these bearing devices 3 can be designed in any manner per se, such as roller bearings or plain bearings and/or magnetic bearings. In order to set the rotor 1 in rotation, a drive device 4 acts on it, which can be designed, for example, as an electric motor, which can transmit a torque to the rotor 1 directly or via a gear unit (not shown).

The rotatable rotor 1 has a rotatable drum 10. It may further comprise as a drive element, for example, a drive spindle 11 for rotating the drum 10, as well as one or more further elements.

The non-rotatable assembly 2 has a machine frame 20, as well as a hood 21 for covering the drum 10. Furthermore, it may comprise further elements such as a solids trap 22, as well as possibly further elements such as one or more lines, damping elements, a lubricant treatment unit, etc. Such elements are shown here only schematically or are not shown, since those skilled in the art are familiar with them and can therefore advantageously design them without further information.

The drum 10 has an inlet 101, a distributor 102, optionally a disc pack 103 consisting of separating discs 104, at least one first outlet 105 for a liquid phase and optionally at least one second outlet 106 for a solid phase. Optionally, a further outlet (not shown here) can be provided, for example, for discharging a further liquid phase.

The drum 10 can be designed for continuous operation. It can preferably have a vertical axis of rotation. However, it is also conceivable to align the axis of rotation differently.

The first outlet 105 can be designed as a peeling disc or gripper. However, it can also be of any other design, such as an open drain or a hermetically sealed drain.

The second outlet 106 may be configured for continuous solids discharge and have continuously open solids discharge openings, particularly nozzles 109, for solids discharge.

These one or more nozzles can be designed in such a way that their outlet or passage cross-section can be changed electrically. This could be realized, for example, by an electrically adjustable nozzle needle, which is moved into the passage cross-section and thereby changes the remaining passage cross-section, or by an impact body, which is pushed electrically adjustably in front of the nozzle opening and thereby creates a gap with variable gap width.

The electrical power for this is preferably provided from the battery described, and the control signals are sent by radio from the machine control system to a corresponding receiver and control electronics for the required actuators.

The drum 10 can be of single or double conical design (inside and/or outside). It is then advantageous to arrange the second outlet 106 in the area of the largest diameter of the drum. In this case, several of the solids discharge openings can be formed in the drum in a circumferentially distributed manner in order to form the second outlet 106.

However, the second outlet 106 may also include intermittently openable or closable solids discharge openings 107.

In this case, the solids discharge openings 107 are assigned at least one closing valve 108 which can be opened and closed electrically. Preferably, each of the solids discharge openings 107 is assigned one of the closing valves 108, with which the solids discharge openings 107 can be opened and closed discontinuously. Thus, these valves form one of the loads.

In the event that the solids discharge openings 107 are closed and opened by a conventional hydraulic piston slide valve (not shown here), the hydraulic fluid required for this purpose, usually control water, can be fed under the piston slide valve for closing by means of electromechanical valves located in the rotating drum and can also be discharged from there for opening.

Here, too, the electrical power is provided by the battery described above, and the control signals are sent by radio from the machine controller to a corresponding receiver and control electronics for the required actuators.

In this way, a flowable product to be processed can flow into the drum 10 where phase separation occurs in the centrifugal field, and the separated phases can be discharged separately from the drum 10 by various outlets 105, 106.

The drum 10 may be designed for liquid-solid separation—as shown—or (not shown) for liquid-liquid separation or for liquid-liquid-solid separation.

The drum 10 may further be designed for continuous operation. In the context of the invention, however, it can also be designed for batch operation, for example by being designed as a chamber separator which must be opened from time to time to remove the solids accumulating on the outside of the drum.

In a preferred design, the centrifuge can be designed as a disc separator. Such an example is shown in FIG. 1. However, in particular individual or all features of the following description relating to the electronics and in particular the power supply of loads on the rotor as well as data transmission can also be implemented on centrifuges of other designs.

The centrifuge further comprises an electronic assembly 5. This electronic assembly comprises elements associated with the stationary assembly 2 and elements associated with the rotor 1.

One or more loads 50 for consuming electrical power (i.e., one or more loads) are arranged in or on the rotor 1, which thus rotate with the rotor during operation.

These loads 50 may include, for example, one or more of the following devices: a sensor 501, an actuator 502, and/or an initiator 503, and/or a transmitting and/or receiving unit 504, and/or a control unit in or on the rotor, and/or a data memory 506 in or on the rotor.

Here, by way of example, the closing valves 108 are designed in the form of solenoid valves that require electrical power to actuate them. They thus also form a load 50 in the form of an actuator 502. In addition, one or more sensors 501 are arranged on the rotor 1, in particular on or in the drum 10.

In order to supply the loads 50 with energy, a battery 51 is arranged on or in the rotor 1. A battery in the sense of the invention is a storage device for electrical power on an electrochemical basis. The battery 51 can be designed as a rechargeable battery, i.e., as an accumulator, in short power pack or secondary battery. However, it can also be designed as a non-rechargeable battery, called a primary battery for short.

The battery 51 may be used to power one or more loads 50.

A non-rechargeable battery 51, which thus has to be changed from time to time when the rotor 1 is stationary and operation is interrupted, can be used in particular to supply one or more loads 50 with a low energy requirement, such as to supply a transmitting and/or receiving unit 504 of the rotor 1, in particular a radio transmitter, especially one using a radio standard with a relatively low energy requirement.

A rechargeable battery 51, on the other hand, can also be used to supply one or more loads with a higher power requirement, such as for actuating one or more solenoid valves, in particular designed as closing valves 108. The battery can also be used to electrically actuate the mechanism for changing the outlet or passage cross-section of a nozzle 109.

For fast-switching electrovalves, which can also open and close the required cross-sections at solids discharge openings, “several 10 watts” of power are required for actuation. If several, e.g., 10 to 20, valves are now distributed on the drum circumference, “some 100 watts” or more are required for tenths of seconds and constant voltage. It is possible to provide this power for modern batteries such as NiMh batteries or lithium-ion batteries. These could also be installed decentrally at the respective load/valve in order to then be centrally controlled.

If the battery 51 is formed as a rechargeable battery 51, it may be provided that an arrangement 52 for inductively generating electrical power is formed directly on the separator for at least charging the rechargeable battery 51. A charging circuit 523 may be formed between the arrangement 52 and the battery 51 to rectify the energy or induced voltage generated by the arrangement 52 and to provide it suitably to the terminals of the battery 51 for charging the battery 51.

The arrangement 52 may be formed in various ways. It may comprise one or more first elements not rotating with the rotor, such as one or more magnets 521 associated with the stationary assembly 2 and one or more inductors (coils) 522 associated with the rotatable rotor 1, wherein the arrangement is such that in operation, i.e., when the drum is rotated, current is induced in the coil or coils 522 as the coils rotate past the magnet or magnets 521, so that electrical power is generated directly in the rotating system or rotor 1.

According to a first possible design, this energy generated in the rotating system or rotor 1 can be generated continuously during the complete revolutions of the rotor or only—in relation to the circumference—in certain areas, i.e., when the respective coil 522 moves past the magnet 521 during its revolution. This can be influenced by the corresponding circumferential distribution and a corresponding dimensioning of the number of magnets 521 and coils 522. In this way, the coils 521 themselves also form part of the rotor 1 and rotate with it during operation.

The one or more loads 50 may be coupled to the battery directly or through intermediary components and form a circuit therewith (not shown). The arrangement 52 may be located at positions suitable for inductors (coils) 522 attached to the drum to pass close to the stationary magnet 521. This may be at the bottom or top of the drum, but also at the outer circumference of the drum, or in the area of the drive spindle or in the area of the inlet or outlet.

Each load 50 can be assigned a respective transmitting and/or receiving unit 504, or several of the loads 501, 502, 503 can be assigned a common transmitting and/or receiving unit 504 of the rotor 1. In FIG. 1, transmitting and/or receiving units 504 are schematically represented by a kind of fan-like signal symbol. They may be arranged directly on the sensors 501 or may be formed together with them as a structural unit. Preferably, they each comprise an antenna, in particular an antenna projecting outwardly from the drum 10 or attached to the outside of the drum.

In FIG. 1, sensors 501 are shown purely schematically. The way they are shown exemplifies a type of function of the respective sensor 501, such as that of a filling level measurement (upper right sensor 501), a temperature sensor (upper left sensor 501) or a strain sensor (sensor on the far left).

The transmitting and/or receiving unit(s) 504 of the rotor may be designed to transmit data or signals and/or to receive data or signals. They may use any standard per se for this purpose, such as Bluetooth or Near Field Communication (NFC) or light signals (light in the visible range). Preferably, the transmitting and/or receiving unit 504 is formed as a transmitting and/or receiving unit that uses a radio standard with a low power requirement.

Outside the rotor, a corresponding transmitting and/or receiving unit 505 is arranged in particular on the stationary assembly 2. The transmitting and/or receiving unit 505 on the stationary assembly 2 can also be designed to receive data or signals and/or to transmit data and/or signals. Preferably, the transmitting and/or receiving unit 504 is formed as a transmitting and/or receiving unit that operates with a radio standard with a low power requirement.

The transmitting and/or receiving unit 505 is preferably connected to a control device 53 of the separator.

The data and/or signal transmission between the transmitting and/or receiving units 504, 505 may be in one direction only or in two directions.

Thus, it is conceivable that only data about the operating state of the rotor 10 or in the rotor—detected, for example, by one or more of the sensors 501—are transmitted from the transmitting and/or receiving unit 504 of the rotor 1 to the transmitting and/or receiving unit 505, so that these can be evaluated, for example, with the control device 53.

However, it is also conceivable that conversely, for example, data and/or signals are transmitted from the transmitting and/or receiving unit 505 of the assembly 2 to the transmitting and/or receiving unit 504 of the rotor 1 in order to control an actuator 502, for example.

In addition, combinations and variants of these transmission types are conceivable.

The battery 51 may be located in the drum at various locations. For example, the battery can be placed in a receptacle in or on the lower part of the drum or in the upper part of the drum.

The transmitting and/or receiving unit(s) 504 of the rotor are preferably arranged such that their antenna(s) protrude outwardly from the rotor, for example in a conical region of the upper part of the drum.

According to FIG. 1, buffered energy is also available when the drum is stationary. Thus, even when the drum is stationary, actuators 501 such as the valves 108 can be moved and/or data and/or signals from sensors and feedback signals from the actuators can be transmitted wirelessly.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

Rotatable rotor 1
Drum 10
Drive spindle 11
Inlet 101
Distributor 102
Disc pack 103
Separating disc 104
First outlet 105
Second outlet 106
Solids discharge openings 107
Closing valves 108
Nozzle 109
Stationary assembly 2
Machine frame 20
Hood 21
Solids trap 22
Bearing device 3
Drive device 4
Electronic assembly 5
Load 50
Sensor 501
Actuator 502
Initiator 503
Transmitting and/or receiving unit 504, 505
Data memory 506
Battery 51
Arrangement 52
Magnets 521
Inductors (coils) 522
Charging circuit 523
Control device 53

1-23. (canceled)

24. A centrifuge, comprising:
a rotatable rotor; and
an assembly that is stationary during operation of the centrifuge,
wherein the rotatable rotor is rotatably mounted in or on the stationary assembly by one or more bearing devices,
wherein the rotatable rotor comprises a rotatable drum, a drive element for rotating the drum, and one or more electrical loads arranged on or in the rotatable rotor, and
wherein the centrifuge further comprises at least one battery electrically coupled to supply the one or more electrical loads with electrical power,
wherein the at least one battery is arranged on or in the rotatable rotor, and
wherein the one or more electrical loads include at least one actuator.

25. The centrifuge of claim 24, wherein the at least one battery is a rechargeable battery.

26. The centrifuge of claim 24, wherein the at least one battery is a non-rechargeable battery.

27. The centrifuge of claim 24, further comprising:
a disc pack arranged in the rotatable drum, wherein the disc pack has a stack of separating discs.

28. The centrifuge of claim 24, the one or more electrical loads include a data memory in the rotatable rotor or on the rotatable rotor.

29. The centrifuge of claim 24, wherein the one or more electrical loads are arranged in or one the rotatable rotor and comprise a sensor, an actuator, an initiator, a transmitting unit, a receiving unit, a transmitting and receiving unit, or a control unit.

30. The centrifuge of claim 24, wherein the at least one battery is a rechargeable battery, the centrifuge further comprising:
an electrical power generating arrangement, which is configured such that electrical power is provided in the rotatable rotor, and a charging circuit configured to charge the rechargeable battery.

31. The centrifuge of claim 30, wherein the electrical power generating arrangement is configured to generate electrical power only during part of revolutions of the rotatable rotor.

32. The centrifuge of claim 30, wherein the electrical power generating arrangement is configured to generate electrical power during the complete revolutions of the rotatable rotor.

33. The centrifuge of claim 24, wherein the rotor further comprises a data memory or a control device, wherein the data memory or the control device is one of the one or more electrical loads.

34. The centrifuge of claim 29, wherein the one or more electrical loads include the sensor.

35. The centrifuge of claim 29, wherein the one or more electrical loads include the actuator, wherein the actuator is a solenoid valve or an electrically actuatable control valve.

36. The centrifuge of claim 29, wherein the one or more electrical loads include the actuator, wherein the actuator is a solenoid valve or an electrically actuatable control valve configured to open or close solids discharge openings of the rotatable drum or to change a cross-section of one or more solids discharge openings of the rotatable drum.

37. The centrifuge of claim 24, wherein the rotatable drum comprises an inlet and at least two different outlets.

38. The centrifuge of claim 24, wherein the rotatable drum has a vertical axis of rotation.

39. The centrifuge of claim 24, wherein the rotatable drum has single or double conical configuration on an inside or an outside.

40. The centrifuge of claim 24, wherein the centrifuge is configured as a disc separator or as a solid drum screw centrifuge.

41. The centrifuge of claim 29, wherein the one or more electrical loads include the transmitting unit, the receiving unit, or the transmitting and receiving unit, and wherein the transmitting unit, the receiving unit, or the transmitting and receiving unit are arranged on or in the rotatable rotor.

42. The centrifuge of claim 41, wherein the transmitting unit, the receiving unit, or the transmitting and receiving unit comprises an antenna projecting from the rotatable rotor and is configured for wireless communications.

43. The centrifuge of claim 42, further comprising:
a corresponding transmitting unit, receiving unit, or transmitting and receiving unit arranged on the stationary assembly and configured for wireless communication.

44. The centrifuge of claim 43, wherein the corresponding transmitting unit, receiving unit, or transmitting and receiving unit is connected to a control device that controls the centrifuge.

45. The centrifuge of claim 24, further comprising:
solids discharge nozzles,
wherein the one or more electrical loads include an electrically controllable device that varies a nozzle cross-section of the solids discharge nozzles,
wherein the electrically controllable device is
an electrically adjustable nozzle needle that is movable into a passage cross-section of the solid discharge nozzles, wherein a remaining passage cross-section of the solid discharge nozzles can be varied, or
an impact body that is pushed electrically adjustably in front of nozzle opening of the solids discharge nozzles to form a gap with variable gap width.

46. The centrifuge of claim 24, wherein the rotatable drum has a hydraulically actuatable piston slide valve configured to open and close one or more solids discharge openings of the rotatable drum, wherein hydraulic fluid is dischargeable from a control chamber on or under the hydraulically actuatable piston slide valve by one or more electromechanical valves as one of the one or more electrical loads, wherein the electromechanical valves are arranged on or in the rotating drum to open the hydraulically actuatable piston slide valve.
